(19) United States
(12) Patent Application Publication
(10) Pub. No.: US 2026/0101155 A1
(43) Pub. Date: Apr. 9, 2026

(54) EXPANDABLE MIX-ZONES AS A DECEPTION TECHNIQUE FOR PROVIDING LOCATION PRIVACY ON INTERNET OF THINGS (IOT)

(71) Applicant: FLORIDA ATLANTIC UNIVERSITY BOARD OF TRUSTEES, Boca Raton, FL (US)

(72) Inventors: Ismail Butun, Boca Raton, FL (US); Imadeldin Mahgoub, Boca Raton, FL (US)

(21) Appl. No.: 19/350,325

(22) Filed: Oct. 6, 2025

Related U.S. Application Data
(60) Provisional application No. 63/703,462, filed on Oct. 4, 2024.

(51) Int. Cl. H04W 4/029; H04W 4/02; H04W 4/021; H04W 4/70; H04W 12/02

(52) U.S. Cl. CPC H04W 4/029; H04W 4/022; H04W 4/023; H04W 4/70; H04W 12/02

(57) ABSTRACT

Systems and methods including expandable mix-zones as a deception technique for providing location privacy on the Internet of Things (IOT) are disclosed herein. A computing device can be configured to receive geographical information corresponding with a geographical location, wherein the geographical information defines at least one expandable mix-zone; and responsive to determining that the at least one computing device is located within the at least one expandable mix-zone, activate location masking operations to conceal (e.g., anonymize, obscure) the location of the computing device while it is within the at least one expandable mix-zone.

### CROSS-REFERENCE TO RELATED APPLICATIONS

This application claims priority to and the benefit of U.S. Provisional Application No. 63/703,462, titled “EXPANDABLE MIX-ZONES AS A DECEPTION TECHNIQUE FOR PROVIDING LOCATION PRIVACY ON INTERNET OF THINGS (IOT),” filed on Oct. 4, 2024, the content of which is incorporated by reference herein in its entirety.

### STATEMENT REGARDING FEDERALLY SPONSORED RESEARCH OR DEVELOPMENT

This invention was made with government support under grant number W911NF2010300 awarded by the Office of the Secretary of Defense. The government has certain rights in the invention.

### BACKGROUND

Internet of Battlefield Things (IoBT) constitutes the next generation of combat-aid services intended to excel in the battlefield operations of the teams on the ground such as seals and special operation units. It is a concept derived from the broader notion of the Internet of Things (IOT), which is the network of interconnected devices that can communicate and exchange data over the Internet. In some cases of the challenging operational environments, where IoBT is deployed, it might be of utmost importance to preserve the exact locations of the soldiers on the field. This concept is referred to as location privacy, and the act of safeguarding location privacy is termed as ‘deception’, which forms the central theme of this disclosure.

There is a need for methods and systems that can preserve location privacy in mission critical contexts in a manner that optimizes the use of computational resources to meet operational demands.

### SUMMARY

Systems and methods including expandable mix-zones as a deception technique for providing location privacy on the Internet of Things (IOT) are disclosed herein. While the battlefield environment is described as a use case for technology validation, the implication of the technology's success and application is much greater-evolving beyond the security of location privacy in IoBT to that of IoT. The mix-zones technology facilitates the amalgamation and anonymization of multiple user locations within expansible spatial boundaries, thereby offering a robust mechanism for preserving location privacy amidst dynamic battlefield environments. This technology has further evolved to include a framework with a Random Walk model, thereby fortifying the theoretical underpinnings with empirical evaluation. Specifically, endeavors to assess the approximate accuracy of position information within and outside the mix-zone boundaries. Through the integration of the Random Walk model, the dynamic interplay between location privacy preservation and the inherent uncertainty intrinsic to battlefield environments is explored with reference to a study described in more detail below. The proposed expandable mix-zones are adaptive and can be re-sized according to the unique requirements of the current context of the person-of-interest (POI). Adaptability and environmental sensing capabilities provide many advantages to the overall system/network, not only enhancing the location-privacy of the users but also improving the system performance when needed/desired. Embodiments of the present disclosure can be adapted for various applications including telecommunications, vehicle systems, military and law enforcement applications, and the like. In the dynamic landscape of modern warfare, ensuring the confidentiality of location data within the IoBT is imperative for maintaining operational security and strategic advantage. As military forces increasingly rely on interconnected networks of sensors, devices, and unmanned systems to gather intelligence and coordinate operations, the risk of adversaries exploiting location information for malicious purposes becomes ever more pronounced. As a conclusion of this paper, the concept of mixed-zones emerges as a promising strategy for addressing location privacy concerns within IoBT. Through strategic deployment in sensitive battlefield areas like military bases and conflict zones, mixed-zones offer users heightened anonymity and protection against potential adversaries. However, it's crucial to recognize the inherent limitations, especially the risk of sophisticated adversaries leveraging timing and velocity estimates to infer user locations. Moreover, the efficacy of mixed-zones heavily relies on collaborative user participation in pseudonym exchange and anonymity maintenance.

Therefore, while mixed-zones present a valuable tool for enhancing location privacy in IoBT, their successful implementation requires careful consideration of user cooperation and ongoing efforts to mitigate potential vulnerabilities and threats. Future research could delve into exploring AI-powered attacks within the IoBT framework. While evaluations using the Random Walk model in a Python environment have been conducted, the potential vulnerabilities and countermeasures against AI-based threats remain unexplored.

In some implementations, a system is provided. The system can include: at least one computing device, the at least one computing device including: at least one processor; and a memory having instructions thereon, wherein the instructions when executed by the processor, cause the at least one processor to: receive geographical information corresponding with a geographical location, wherein the geographical information defines a plurality of expandable mix-zones, wherein the plurality of expandable mix-zones is adjustable/adaptable in real-time based on a control signal or modification provided by a command center or computing device; and responsive to determining that the at least one computing device is located within at least one expandable mix-zone, activate location masking operations to conceal (e.g., anonymize, obscure) the location of the computing device while it is within at least one expandable mix-zone according to a corresponding priority level associated with the respective expandable mix-zone.

In some implementations, the instructions when executed by the at least one processor, cause the at least one processor to further: responsive to determining that the at least one computing device is positioned outside of the at least one expandable mix-zone, deactivate the location masking operations.

In some implementations, the location masking operations preserve and/or modulate access to short-term location information for Location-Based Services (LBS).

In some implementations, the plurality of expandable mix-zones includes a first zone, a second zone, and a third zone do not intersect with one another and are concentrically nested within one another.

In some implementations, the plurality of expandable mix-zones includes a plurality of expandable mix-zones including at least a first mix-zone, a second mix-zone, and a third mix-zone, wherein each mix-zone is associated with a different location masking operation and/or priority level.

In some implementations, the instructions when executed by the at least one processor, cause the at least one processor to further: determine a priority level for the at least one computing device based on a geographic zone (zone 1, zone 2, zone 3) within the plurality of expandable mix-zones; and determine/activate location masking operations based on the determined priority levels.

In some implementations, the at least one computing device is further configured to: monitor environmental conditions via one or more sensors; and. modify or augment the location masking operations based on detected environmental conditions.

In some implementations, the at least one computing device includes at least one of an Internet of Things (IOT) device, an Internet of Battlefield Things (IoBT) device, and a Medical IoT device.

In some implementations, the at least one computing device includes at least one of a drone, a tracking device, a wearable device, a mobile device, and an unmanned aerial vehicle (UAV).

In some implementations, performance of the at least one expandable mix-zone is modeled, analyzed, and/or optimized offline or by a command center using a Random Walk model.

In some implementations, the at least one computing device includes a plurality of interconnected devices (e.g., IoT and/or IoBT devices) in electronic communication over a network.

In some implementations, a computer-implemented method is provided. The method can include: receiving, by at least one processor, geographical information that defines a plurality of expandable mix-zones, wherein the plurality of expandable mix-zones is adjustable/adaptable in real-time based on a control signal or modification provided by a command center or remote device; receiving, by the at least one processor, location information for at least one computing device within one of the expandable mix-zones; and responsive to determining that at least one computing device is located within one of the expandable mix-zones, activating, by the at least one processor, location masking operations to conceal (e.g., anonymize, obscure) a location of the at least one computing device while it is within the expandable mix-zone according to a corresponding priority level associated with the respective expandable mix-zone.

In some implementations, the computer-implemented method further includes: prior to receiving the geographical information, establishing or defining, by the at least one processor, the plurality of expandable mix-zones including at least a first zone corresponding with a first geographic area, a second zone corresponding with a second geographic area, and a third zone corresponding with a third geographic area.

In some implementations, the first zone, the second zone, and the third zone do not intersect with one another and are concentrically nested within one another.

In some implementations, the computer-implemented method further includes: responsive to determining that the at least one computing device is positioned outside of the plurality of expandable mix-zones, deactivating, by the at least one processor, the location masking operations.

In some implementations, the location masking operations preserve and/or modulate access to short-term location information for Location-Based Services (LBS).

In some implementations, the computer-implemented method further includes: determining, by the at least one processor, a priority level for each expandable mix-zone; and determining/activating, by the at least one processor, location masking operations within each zone for one or more computing devices based on the determined priority levels.

In some implementations, the computer-implemented method further includes monitoring, by the at least one processor, environmental conditions via one or more sensors of the at least one computing device; and. modifying or augmenting, by the at least one processor, the location masking operations and/or reconfiguring the plurality of expandable mix-zones based on detected environmental conditions.

In some implementations, performance of the plurality of expandable mix-zones is modeled, analyzed, and/or optimized offline or by a command center using a Random Walk model.

In some implementations, a non-transitory computer-readable medium is provided. The non-transitory computer readable medium can include a memory having instructions stored thereon which when executed by a processor cause the processor to at least: receive geographical information corresponding with a geographical location, wherein the geographical information defines a plurality of expandable mix-zones, and wherein the plurality of expandable mix-zones is adjustable/adaptable in real-time based on a control signal or modification provided by a command center or remote device; and responsive to determining that at least one computing device is located within the at least one expandable mix-zone, activate location masking operations to conceal the location of the at least one computing device while it is within at least one expandable mix-zone according to a corresponding priority level associated with the respective expandable mix-zone.

### BRIEF DESCRIPTION OF THE DRAWINGS

The accompanying drawings, which are incorporated in and constitute a part of this specification, illustrate embodiments and, together with the description, serve to explain the principles of the methods and systems. The patent or application file contains at least one drawing executed in color.

FIG. 1A is an example system in accordance with certain embodiments of the present disclosure.

FIG. 1B illustrates expandable mix-zones in accordance with certain embodiments described herein.

FIG. 1C shows graphs demonstrating the effectiveness of the mix-zones for IoBT deployments.

FIG. 1D are graphs depicting additional experimental results.

FIG. 2 is a flowchart of an example method in accordance with certain embodiments of the present disclosure.

FIG. 3 is an example computing device.

It should be appreciated that the logical operations described herein with respect to the various figures may be implemented (1) as a sequence of computer-implemented acts or program modules (i.e., software) running on a computing device (e.g., the computing device described in FIG. 2), (2) as interconnected machine logic circuits or circuit modules (i.e., hardware) within the computing device and/or (3) a combination of software and hardware of the computing device.

### DETAILED DESCRIPTION

Each and every feature described herein, and each and every combination of two or more of such features, is included within the scope of the present disclosure, provided that the features included in such a combination are not mutually inconsistent.

In the realm of military operations and defense, the IoBT emerges as a specialized application of interconnected technologies, strategically harnessed to augment situational awareness, decision-making processes, and overall operational efficacy on the battlefield. Within this domain, IoBT orchestrates the seamless integration of an array of smart devices, sensors, unmanned systems, and interconnected technologies, each meticulously calibrated to enhance military capabilities in dynamic and challenging environments. Additionally, these devices encompass a diverse array, ranging from drones and unmanned ground vehicles to surveillance sensors, communication systems, and wearable technologies tailored for soldiers' use [1]. Historically, conventional military stratagems have leveraged deception techniques to confound adversaries, exemplified by tactics such as planting fabricated evidence to distort invasion plans or deploying decoys like inflatable tanks and dummy aircraft to safeguard military assets [2]. These time-honored methods underscore the enduring utility of deception in warfare. However, the contemporary theater of conflict has evolved to embrace cutting-edge technology, with modern warfare scenarios characterized by the proliferation of IoT devices. In the contemporary battlefield milieu, soldiers are outfit ted with an arsenal of advanced gadgets, including personal wearable devices, air tag-like location tracking mechanisms, and unmanned aerial vehicles (UAVs) or drones. The pervasive integration of IoT devices into military operations has ushered in a new era of combat capabilities, enabling troops to wield these technologies with unprecedented efficiency and precision [3]. Moreover, the advent of satellite-based internet providers like Starlink has revolutionized communication infrastructures in developing regions, rendering internet connectivity a pivotal enabler in the evolution of IoT into IoBT. Indeed, the seamless availability of internet services has emerged as a cornerstone in the transformation of military operations, underscoring the pivotal role played by networked technologies in contemporary conflict scenarios [4].

Numerous recent conflicts, including the Yemen Conflict, Syrian Civil War, Nagorno-Karabakh Conflict, and the on-going Ukraine-Russia conflict, have witnessed the strategic deployment of IoT devices for surveillance, reconnaissance, and tactical operations [5]. Sensors, cameras, drones, and a plethora of IoT-enabled devices have been employed to monitor enemy positions, gather real-time intelligence, and facilitate precision targeting for artillery and missile strikes. IoBT architectures enable military forces to harness real-time data from diverse sources, enabling swift analysis and informed decision-making processes [6]. In essence, IoBT epitomizes a specialized instantiation of the broader IoT paradigm, meticulously tailored to meet the military exigencies. Whereas IoT encompasses the interconnected network of devices across diverse domains, IoBT specifically directs its focus toward optimizing military capabilities, fostering enhanced situational awareness, and facilitating informed decision-making in the theater of conflict. This entails the seamless integration of sensors, unmanned systems, communication devices, and other smart technologies into military infrastructure, thereby empowering commanders with a comprehensive battlefield perspective [7].

Wireless Sensor Networks (WSNs) assume a pivotal role within the IoBT ecosystem, serving as the foundational infrastructure for data collection and transmission from field-deployed sensors. These sensors fulfill diverse functions, encompassing environmental monitoring, threat detection, and intelligence gathering, thereby bolstering military operations such as surveillance, reconnaissance, and target acquisition [8].

Cyber-physical systems (CPSs) constitute another indispensable facet of IoBT, facilitating seamless interaction between IoT devices and physical processes/systems to monitor, regulate, and optimize operations in real-time. In military contexts, CPSs enable the seamless integration of IoT technologies with existing command and control structures, weapon systems, and vehicular assets, thereby amplifying battlefield capabilities and responsiveness [9].

The potential utilization of IoT devices in battlefield contexts is contingent upon myriad factors, including technological capabilities, operational exigencies, and strategic considerations. However, the subsequent delineation encapsulates general insights into the prospective applications of IoT devices in military domains [10]-[12]:

Surveillance and Reconnaissance: Unmanned aerial vehicles (UAVs) or ground-based sensors serve as viable options for surveillance and reconnaissance missions, facilitating real-time data acquisition on enemy movements, troop deployments, and other pertinent intelligence.

Communication and Coordination: IoT devices foster secure and efficient communication and coordination among military units, exemplified by wearable gadgets, smart helmets, and analogous equipment designed to facilitate information exchange, soldier tracking, and situational awareness enhancement on the battlefield [13].

Asset Tracking and Logistics: IoT sensors find utility in tracking and monitoring military assets, spanning vehicles, equipment, and supply convoys. Real-time asset visibility afforded by IoT deployments augments logistical efficacy and operational efficiency.

Cybersecurity and Network Defense: IoT devices bolster cybersecurity frameworks in warfare scenarios, enabling real-time monitoring, threat detection, and incident response mechanisms to safeguard critical infrastructure and military networks against cyber threats [14].

Battlefield Medical Monitoring: IoT sensors play a pivotal role in monitoring soldier health and well-being on the battlefield, equipped to track vital signs, detect injuries, and transmit pertinent medical data to healthcare personnel, thereby facilitating prompt intervention and enhanced medical support [15].

Environmental Monitoring: IoT devices facilitate com prehensive environmental monitoring on the battlefield, encompassing assessments of air quality, radiation levels, and chemical agent detection. This environmental intelligence informs decision-making processes, hazard assessments, and safeguards for military personnel [16].

By cooperatively integrating IoT, WSNs, and CPSs, IoBT empowers military forces to attain numerous key objectives and achievements, including but not limited to enhanced situational awareness, improved command and control operational efficiency, increased mission effectiveness, reduced personnel risk, adaptive and resilient operations, enhanced logistics and supply chain management, expedited decision-making, and enhanced interoperability. These salient features will be expounded upon herein to provide comprehensive insights into the transformative potential of IoBT in military contexts. In summary, IoBT represents a significant advancement in modern warfare, leveraging IoT, WSNs, and CPSs to enhance the capabilities, agility, effectiveness, and responsiveness of military forces in today's dynamic and unpredictable battlefield environments in various operational scenarios.

The integration of IoT technologies within military frameworks heralds transformative possibilities across a spectrum of operational domains, underpinning enhanced situational awareness, operational efficacy, and mission success in contemporary conflict theaters [17].

### Problem Statement

Geolocation data, which pinpoints an individual's precise location within a radius of approximately 1850 feet, constitutes a subset of personally identifiable information (PII) and play a pivotal role in modern digital ecosystems. While offering valuable insights into user behavior, preferences, and interactions, the collection and utilization of geolocation data raise significant privacy concerns. In response, regulatory frameworks such as the California Consumer Privacy Act (CCPA) and the California Privacy Rights Act (CPRA) include stringent provisions to safeguard individuals' privacy rights [18], [19]. These regulations govern the collection, processing, and disclosure of geolocation data, ensuring transparency, consent, and accountability in its use. Moreover, international measures like the General Data Protection Regulation (GDPR) in the European Union and the Geolocation Privacy Protection Act (GPPA) in the United States provide additional legal frameworks to protect individuals' privacy rights while facilitating the responsible handling of geolocation data [20]. These regulatory efforts underscore the importance of balancing privacy considerations with the legitimate interests of businesses and organizations in leveraging geolocation data for innovation and service enhancement, ultimately fostering trust and accountability in the digital ecosystem.

Geolocation data is not only regarded as personally identifiable information (PII) within civil contexts but also holds significance in various other domains and applications. For instance, in the dynamic landscape of contemporary warfare, the proliferation of Internet-of-Battlefield Things (IoBT) deployments has introduced unprecedented challenges concerning location privacy and security. As military operations increasingly rely on interconnected devices and sensors for enhanced situational awareness and operational effectiveness, safeguarding the confidentiality of sensitive location information emerges as a very big concern. However, the inherent vulnerabilities of IoBT frameworks pose significant risks, potentially exposing soldiers and critical assets to adversaries seeking to exploit location data for malicious purposes [21].

To address this pressing issue, the concept of Expandable Mix-Zones has emerged as a promising deception technique aimed at preserving location privacy within IoBT environments. By obfuscating the precise whereabouts of military personnel and assets through the strategic deployment of mix-zones, this approach seeks to thwart adversarial attempts to track or intercept sensitive location data. Despite its potential efficacy, the implementation of Expandable Mix-Zones poses many challenges, including the need to balance privacy protection with operational requirements, the optimization of mix-zone configurations for diverse battlefield scenarios, and the mitigation of potential trade-offs between security and operational efficiency.

Thus, the overarching problem statement revolves around devising robust strategies and methodologies for the effective deployment and management of Expandable Mix-Zones as a deception technique within IoBT deployments. This entails addressing key research questions about the design, implementation, and evaluation of mix-zone frameworks, as well as the development of comprehensive security protocols to mitigate emerging threats to location privacy in dynamic military environments. By tackling these challenges, this research endeavor aims to contribute in the advancement of IoBT security architecture and the preservation of location privacy in modern warfare scenarios.

There are numerous drivers for the demand for this technology in IoBT. Battlefield environments are inherently unpredictable and often hostile. The constant threat of enemy surveillance and the need for rapid tactical maneuvers make it imperative to protect soldiers' locations. The proposed mix-zones technology could provide a crucial layer of security by obscuring the precise location of individual soldiers within a larger area. Additionally, by anonymizing locations within a mix-zone, elite teams could move more freely and unpredictably, making it difficult for adversaries to anticipate their actions. This would enhance operational flexibility and increase the element of surprise. Furthermore, protecting soldiers' locations is not only about avoiding enemy surveillance but also about preventing targeted attacks. The mix-zones technology could make it more challenging for enemies to identify and isolate individual soldiers, reducing their vulnerability. The mix-zones technology can be employed in various military applications including:

### Enhanced Operational Security:

Counter-surveillance: By anonymizing the locations of individual soldiers within a mix-zone, it becomes more difficult for adversaries to track and target them.

Ambush Prevention: Mix-zones can help prevent ambushes by making it harder for enemies to predict the movement of troops.

Intelligence Gathering: Mix-zones can protect the identities of intelligence assets operating in hostile environments.

### Force Mobility:

Unpredictable Movement: Mix-zones allow troops to move more freely and unpredictably, making it challenging for adversaries to anticipate their actions.

Rapid Deployment: Mix-zones can facilitate the rapid deployment of forces to critical areas without compromising their security.

### Protection of Critical Infrastructure:

Security of Supply Lines: Mix-zones can be used to protect supply lines and critical infrastructure from enemy attacks.

Defense of Forward Operating Bases: Mix-zones can help defend forward operating bases by obscuring the location of troops and equipment.

### Counter-Terrorism Operations:

Disrupting Terrorist Networks: Mix-zones can be used to disrupt terrorist networks by making it more difficult for them to coordinate their activities.

Protecting Hostage Situations: Mix-zones can be used to protect hostages and rescue teams during hostage situations.

### Cyber Warfare Defense:

Protecting Communication Networks: Mix-zones can be used to protect communication networks from enemy cyberattacks by obscuring the location of critical infrastructure.

### Example System

The potential of mix-zones as a deception technique holds significant promise for enhancing location privacy and bolstering the security posture of IoBT deployments, particularly in high-risk operational environments. The motivation behind exploring Expandable Mix-Zones lies in the urgent need to reconcile the imperative of preserving location privacy with the exigencies of modern warfare. By leveraging mix-zones as a proactive defense mechanism, military commanders can mitigate the risks associated with location-based attacks and ensure the operational integrity of elite units operating in hostile territories. Moreover, the adoption of mix-zones aligns with broader efforts to enhance the resilience and adaptability of IoBT frameworks, positioning military forces to effectively navigate the complexities of contemporary conflict scenarios.

Ultimately, the motivation to investigate Expandable Mix-Zones stems from a steadfast commitment to safeguarding the integrity and effectiveness of military operations in an increasingly interconnected and digitally driven battlefield landscape. By harnessing the potential of mix-zones as a deception technique, this research endeavor seeks to empower military forces with the tools and strategies needed to uphold location privacy, protect personnel and assets, and ultimately, preserve the security and sovereignty of nations in the face of evolving threats. In this work, we greatly expand on our previous ideas shared in [22], by further exploring the concept of Expandable Mix-Zones to enhance location privacy within Internet-of-Battlefield Things (IoBT) deployments. Our study delves into the practical implementation and rigorous analysis of these mix-zones through Random Walk Model (RWM) simulations and evaluations.

We introduce a detailed simulation environment using Python to model the movement of military units within designated mix-zones, aiming to obscure their precise locations and protect them from adversaries. The mix-zone concept is expanded into three concentric circles, each offering varying degrees of location privacy: the innermost circle provides high privacy, the middle circle offers medium privacy, and the outermost circle gives low privacy. This tiered approach ensures that military units can benefit from enhanced location privacy as they navigate through different zones, making it more difficult for adversaries to accurately pinpoint their positions.

Our analysis via RWM simulations involved multiple parameters, such as the number of steps taken by the units, the span area of the movement, and the randomness of their start and end locations. The simulation results, including the Root Mean Square Error (RMSE) within and outside the mix-zones, provide a quantitative measure of the effectiveness of our proposed method. Specifically, the average RMSE within the mix-zone was found to be significantly higher compared to that outside the mix-zone, indicating a successful increase in location uncertainty for adversaries. Furthermore, our evaluation highlights the critical role of user cooperation within the mix-zones. The collective participation in pseudonym exchanges and the maintenance of anonymity are essential for the optimal functioning of the mix-zones. Any lapse in this cooperative behavior could undermine the overall effectiveness of the system.

In conclusion, our expanded work on mix-zones offers a robust framework for enhancing location privacy in IoBT environments, particularly in sensitive military contexts. The RWM-based simulations provide a comprehensive evaluation of the proposed method, underscoring its potential to significantly improve the tactical advantage and safety of military units by mitigating the risk of location-based attacks.

Embodiments of the present disclosure provide a system that can be used to activate/trigger location masking operations to conceal (e.g., anonymize, obscure) the location of the computing device while it is within an expandable mix-zone. The location masking operations can be or comprise a “cloaking” technique/methodology, especially for some military-specific applications. The term cloaking can refer to operations performed in a war/combat scenario to protect friendly forces from observation of adversaries.

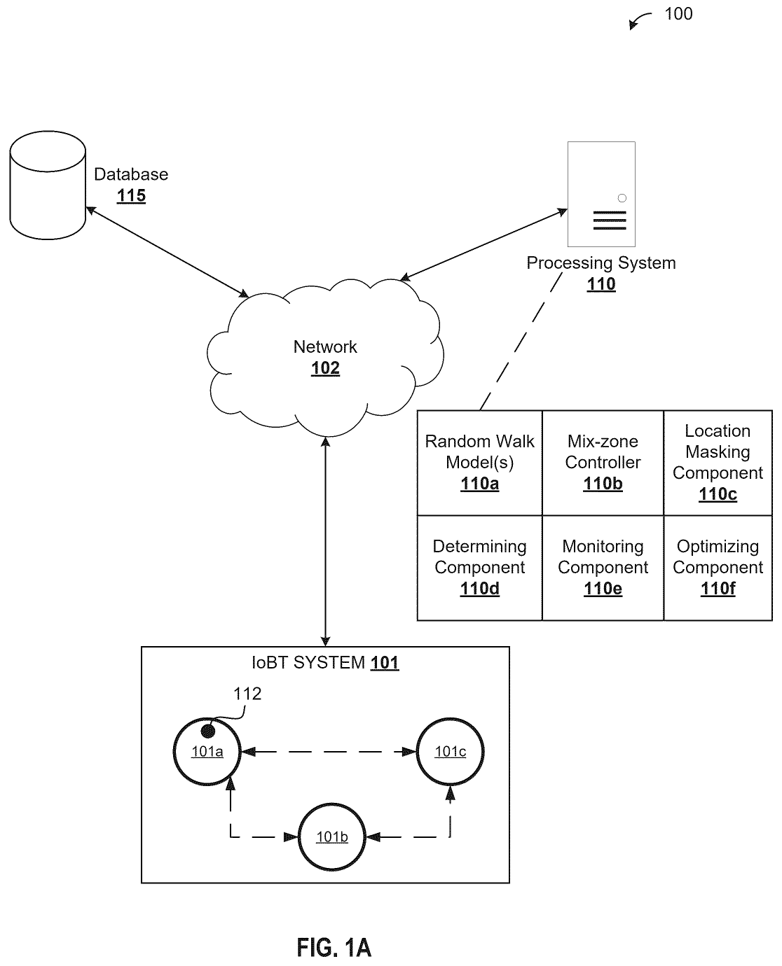

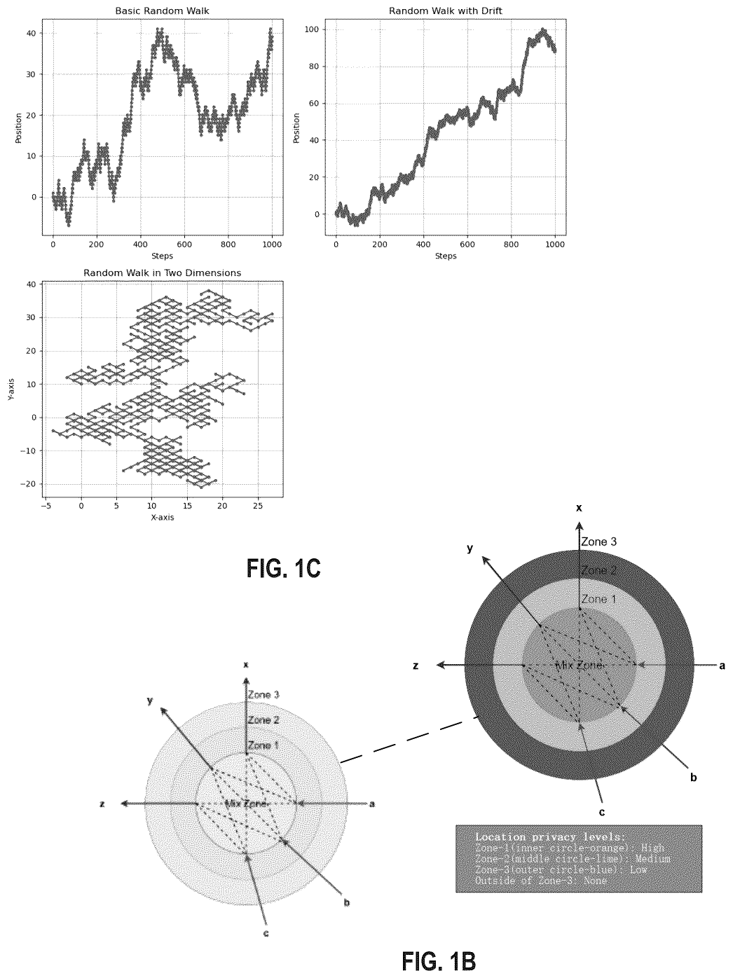

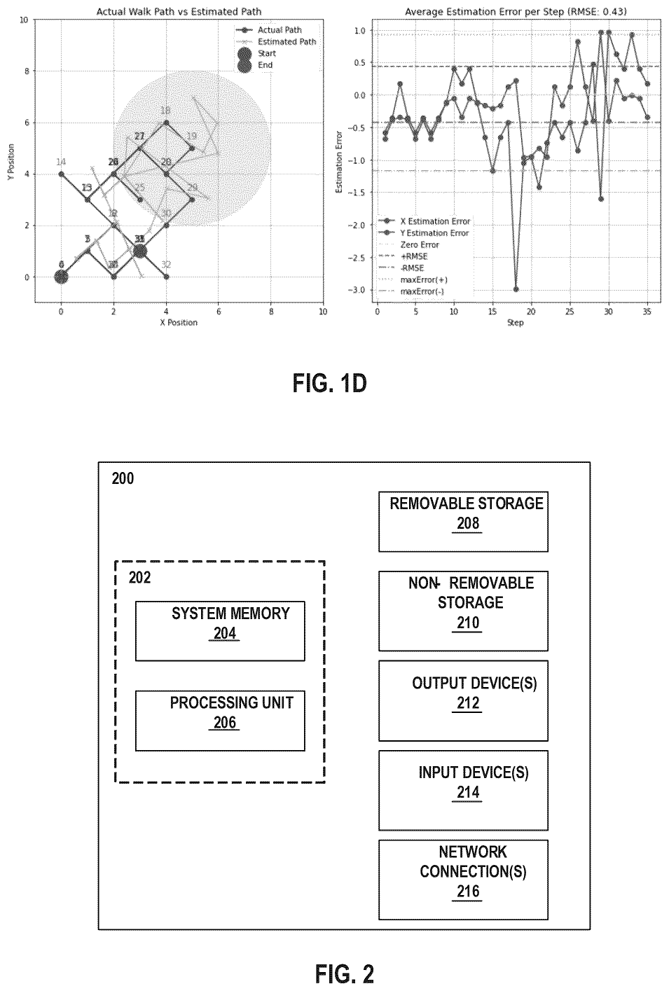

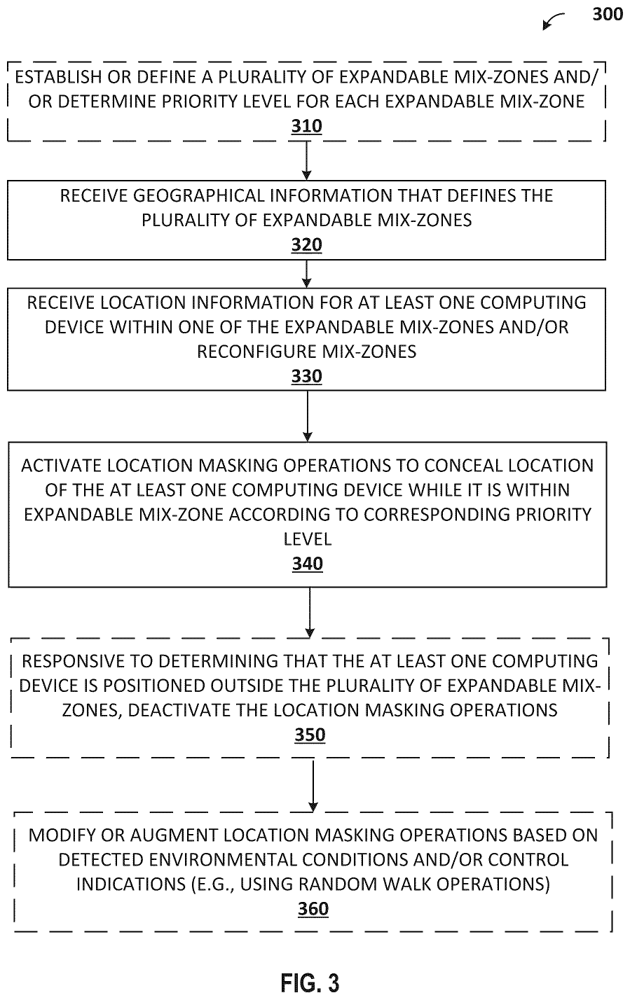

FIG. 1A is an example system 100 in accordance with certain embodiments of the present disclosure. As shown in FIG. 1A, the system 100 includes a processing system 110 (e.g., command center, remote server) configured to communicate with an Internet of Battlefield Things (IoBT) System 101. As shown, the processing system 110 includes one or more Random Walk Model(s) 110a, a mix-zone controller 110b, a location masking component 110c, a determining component 110d, a monitoring component 110e, and an optimizing component 110f configured to perform some or all of the steps/operations described below with reference to FIG. 3. This disclosure contemplates that some or all of the components of the processing system 110 can also be embodied by the IoBT system 101 (e.g., by individual nodes/devices 101a, 101b, 101c of the IoBT system 101). In various implementations, the processing system 110 and the IoBT System 101 are configured to transmit data to and receive data from one another over a network 102 (e.g., the Internet, a private/proprietary communication network). The system 100 can include one or more databases, data stores, repositories, and the like. As shown, the system 100 includes database(s) 115 in communication with the IoBT System 101 and the processing system 110. In some implementations, the database(s) 115 can be hosted by the processing system 110.

In some implementations, as illustrated, the IoBT System 101 comprises a plurality of computing devices 101a, 101b, 101c (e.g., mobile devices, drones, wearable devices, unmanned aerial vehicles (UAVs), or combinations thereof) in electronic communication with one another and/or the processing system 110. The present disclosure contemplates that the IoBT System 101 is not limited to the example depicted in FIG. 1A and can comprise drone systems, vehicle systems, telecommunications systems, Internet of Things (IOT) systems, Medical IoT systems, and/or the like including different devices and/or device types in electronic communication with each other and/or the processing system 110 (e.g., a mobile device in communication with a wearable device).

A Medical IT system in accordance with the present disclosure can be used for tracking patients with various conditions including, for example, Dementia or Alzheimer's Disease. In such examples, the mix-zone can be used to provide patient privacy in clinical and non-clinical settings and can be removed (e.g., deactivated) based on a current context such as during emergencies or whenever a medical need arises.

As further described herein, each of the plurality of computing devices 101a, 101b, 101c can include one or more sensors, sensing devices, or sensing components (terms used interchangeably herein) configured to monitor and/or obtain real-time information/data from the environment (e.g., image data, video data, audio data, body data from one or more individuals, environmental data (e.g., temperature, pressure) and the like). For example, as shown, the first computing device 101a comprises at least one sensing component 112 that can be used to monitor environmental conditions (e.g., air quality, radiation levels, detect chemical agents). The sensing component(s) 112 can be or comprise one or more optical devices, advanced cameras and/or sensors, short range radio detection and ranging (RADAR) sensor(s), accelerometers, gyroscopes, Inertial Measurement Units (IMUs), or combinations thereof.

By way of example, each of the plurality of computing devices 101a, 101b, 101c can be configured to obtain data from its environment that can in turn be used to control/modify operations of the computing device and/or processing system 110 while it is located or positioned within an expandable mix-zone (e.g., modify, modulate, or control location masking operations being performed by the computing device). In some implementations, such information may be sent to the processing system 110 and used to inform reconfiguration of expandable mix-zones in real-time or for later deployment. By way of example, in the event of a medical emergency affecting a particular computing device, the processing system 110 can reconfigure the expandable mix-zones, for instance, by resizing and/or increasing a priority level for the mix-zone where the particular computing device is located. In some implementations, a given computing device 101a, 101b, 101c can transmit information (e.g., environmental data) to a server (e.g., processing system 110) where it may be stored in a database 115 for analysis, to update one or more maps or expandable mix-zone designations, and/or used to generate and send control indications for computing devices (e.g., networking devices within a given expandable mix-zone).

A mix-zone functions as a protective barrier, concealing the precise location of the user while enabling access to short-term location data for Location-Based Services (LBS), thus ensuring user privacy [23], [24]. This approach proves especially advantageous in thwarting the long-term tracking of user behaviors and movements by LBS providers. Mix-zones are strategically designated for sensitive locations like nuclear facilities, military bases, and war zones, where users seek to avoid direct correlation within the location database of Location-Based Services (LBS). System providers predetermine the geographical mapping of Mix-zones, and upon entry, users' precise locations are obscured, with restricted access to LBS. As a result, LBS receives only binary information indicating users' presence within the mix-zone, ensuring anonymity and untraceability. In a combat field where IoBT is deployed, imagine soldiers or mobile units navigating around a central strategic location, symbolized as the focal point of all mix-zones illustrated in FIG. 1B. In this scenario, these units can leverage the location privacy provided within each mix-zone, ensuring their trajectories remain obscure to external observers. Notably, each user's exit point, exemplified by user b, may vary randomly among designated exit points labeled as x, y, or z, each with an equal probability of 1/3. Moreover, the mix-zones can be dynamically expanded, termed as “Expandable Mix-Zones,” transitioning from a condensed Zone-1 to a medium-range Zone-2, or to a more comprehensive Zone-3, as depicted in FIG. 1B which depicts expandable mix-zones for IoBT deployments.

In the concept of our proposed expandable mix-zones, the incorporation of three concentric circles with varying degrees of location privacy-high, medium, and low-reflects a nuanced approach to balancing privacy requirements with operational considerations within Internet-of-Battlefield Things (IoBT) deployments. Several factors are behind this hierarchical arrangement:

1) Granular Privacy Control: By subdividing the mix-zone into three concentric circles, each offering different levels of location privacy, the system can provide users with granular control over the degree of anonymity they wish to maintain. This hierarchical structure enables users to make informed decisions based on their specific operational requirements and threat environments, allowing for greater flexibility and adaptability in IoBT scenarios.

2) Risk Management: The hierarchical arrangement of the circles corresponds to varying levels of risk associated with location disclosure. The inner circle, offering high location privacy, provides maximum protection for sensitive operations or assets requiring utmost confidentiality. In contrast, the outer circle, with lower location privacy, may be suitable for less critical activities where anonymity is less of a concern. This risk-based approach ensures that privacy measures are aligned with the severity of potential threats, thereby optimizing resource allocation and risk management strategies.

3) Resource Optimization: Allocating resources according to the degree of location privacy required in each circle optimizes the utilization of available assets and infrastructure. Resources such as encryption algorithms, pseudonym management systems, and network bandwidth can be tailored to meet the specific privacy needs of each circle, minimizing overhead while maximizing protection. This resource optimization strategy enhances the overall efficiency and effectiveness of the mix-zone concept, ensuring that privacy measures are commensurate with operational demands.

4) Adaptive Security Posture: The hierarchical structure of the mix-zone allows for dynamic adjustments to the security posture based on evolving threat landscapes and operational conditions. For instance, during periods of heightened alert or increased adversary activity, resources may be reallocated to reinforce the inner circle, enhancing location privacy for critical assets or personnel. Conversely, during routine operations or lower threat scenarios, resources may be diverted to support activities in the outer circle, promoting efficiency without compromising security. Overall, the hierarchical arrangement of three inner circles within the mix-zone concept reflects a nuanced and adaptive approach to location privacy management in IoBT deployments. By offering granular control, risk-based allocation of resources, and adaptive security posture, this framework ensures that privacy measures are tailored to the specific needs of each operational context, thereby enhancing the resilience and effectiveness of IoBT systems.

### EXPERIMENTAL RESULTS AND EXAMPLES

1) Random Walk Model: The random walk model is a mathematical concept used to describe the movement of an object or a variable over time where each step is determined by a random process. It is commonly used in finance, physics, biology, and other fields to model phenomena such as stock prices, particle motion, and genetic drift [35]-[37].

a: Basic Random Walk: Consider a one-dimensional random walk where each step can either be to the left or to the right with equal probability. We start at a central point, say 0, and at each time step, we move either one unit to the left or one unit to the right with 50% probability. In this figure, the horizontal axis represents time steps, and the vertical axis represents the position of the walker. The blue dots represent the position of the walker at each time step. As you can see, the walker's position fluctuates randomly over time, and there is no clear trend.

b: Random Walk with Drift: In some cases, there might be a tendency for the walker

to drift in one direction over time. This can be modeled by introducing a drift parameter, which biases the random walk in a particular direction. In this figure, the walker still takes random steps, but there's an overall tendency for it to move to the right due to the drift parameter. However, the randomness is still present, causing fluctuations around the overall trend.

c: Random Walk in Two Dimensions: Random walks can also be extended to two or more dimensions. In a two-dimensional random walk, at each time step, the walker can move in any direction (up, down, left, right) with equal probability. Here, the blue dots represent the position of the walker in a two-dimensional space at each time step. The walker's path forms a random trajectory as it moves around in two dimensions.

The illustrations in FIG. 1C provides a visual representation of how the random walk model works and how it can be applied in different scenarios. The randomness inherent in the model captures the unpredictable nature of many real-world phenomena. FIG. 1D are graphs evaluating the effectiveness of the mix-zones for IoBT deployments from a conducted experiment.

2) Simulation Environment and Background: In this context, the Random Walk Model serves as a foundational concept derived from stochastic processes, where the movement of entities within the mix-zone is characterized by a series of random steps. These steps are influenced by various factors, including user behavior, environmental conditions, and system parameters. Furthermore, the use of Python programming language as a simulator platform facilitates the implementation and analysis of the mix-zone concept. Python provides a versatile and intuitive environment for conducting simulations, enabling researchers to model complex scenarios, execute simulations efficiently, and visualize results effectively. By leveraging Python's capabilities, researchers can explore the dynamics of mix-zone systems, evaluate their performance under different conditions, and assess their effectiveness in preserving location privacy.

While the implementation of mix-zones does involve elements of game theory, particularly in terms of strategic decision-making and interactions among users and adversaries, it may not fully encapsulate a game-theoretical approach to estimating location. Instead, mix-zone implementation typically focuses on enhancing location privacy through techniques such as pseudonymization, obfuscation, and randomization, with the aim of mitigating the risk of location inference by adversaries.

3) Simulation Parameters and Run Case: The simulation parameters for our Python-based simulator is provided in Table 1.

TABLE 1
Parameters for our Python-based simulator that
is used to generate the results in FIG. 1D

| item | value |
|---|---|
| Number of steps | 20 |
| Span area | 10 ft × 10 ft |
| Start location: | (0, 0) |
| End location | pseudo-random (not to be (0, 0)) |
| Steps at mix zone: | [17 18 19 20 21 25 27 28 29] |
| Average RMSE within MixZone | 1.1397 |
| Average RMSE outside of MixZone | 0.4323 |

This simulation run case presents a scenario where military units with an IoBT deployment, navigate a predefined area, incorporating a mix-zone, using a random walk-based Python simulator. Several parameters contribute to the design and execution of this simulation, each serving a specific purpose:

1) Number of Steps: The choice of 20 steps determines the duration of the simulated trajectory, representing a realistic timeframe for military units' movement within the designated area.

2) Span Area: The 10 ft×10 ft span area defines the spatial extent of the simulation, providing sufficient space for military units to navigate and encounter the mix-zone.

3) Start Location: Setting the start location at (0, 0) establishes the initial position of the military units within the simulation area, serving as the point of origin for their trajectory.

4) End Location (Pseudo-random, not (0, 0)): The pseudo-random selection of the end location ensures that the military units' trajectory terminates at a distinct point within the span area, distinct from the start location. This variability mimics real-world scenarios where military units navigate to different destinations.

5) Steps at Mix Zone: The specification of steps at the mix-zone ([17 18 19 20 21 25 27 28 29]) delineates the segments of the trajectory where the military units enter and traverse the mix-zone. These steps are strategically chosen to evaluate the impact of mix-zone entry on location estimation accuracy.

6) Average RMSE within MixZone: The average Root Mean Square Error (RMSE) within the mix-zone (identified as 1.1397 within this simulation) quantifies the discrepancy between the estimated and actual locations of the military units while traversing this region. A higher RMSE value suggests reduced accuracy in location estimation within the mix-zone.

7) Average RMSE outside of MixZone: In contrast, the average RMSE outside of the mix-zone (identified as 0.4323 within this simulation) represents the accuracy of location estimation when the military units operate in regions outside this designated area. A lower RMSE value indicates higher precision in location estimation outside the mix-zone. Overall, this simulation run case aims to assess the impact of mix-zone traversal on location estimation accuracy for military units within Internet-of-Battlefield Things (IoBT) deployments. By analyzing the RMSE values within and outside the mix-zone, researchers can evaluate the efficacy of mix-zone implementation and identify areas for optimization and improvement in future simulations and deployments.

The adversary model in our simulation scenario encompasses entities or systems attempting to capture and exploit the GPS position information of our soldiers within the IoBT deployment. Their objective is to locate and potentially target the military units by analyzing the available position data.

To counteract these adversarial efforts, we employ a mix-zone strategy aimed at concealing the precise GPS positions of our soldiers. The mix-zone operates by cloaking the position information to varying degrees of efficacy within distinct concentric circles:

1) Inner Circle: This circle provides the highest level of cloaking, rendering the soldiers' GPS positions highly obscured and difficult for adversaries to discern. The inner circle serves as the most secure zone within the mix-zone, offering maximum protection against location-based attacks.

2) Middle Circle: Positioned between the inner and outer circles, the middle circle offers a medium level of cloaking for the soldiers' GPS positions. While not as robust as the inner circle, the middle circle still provides substantial concealment, making it challenging for adversaries to accurately pinpoint the soldiers' locations.

3) Outer Circle: The outer circle offers the lowest level of cloaking, providing minimal concealment for the soldiers' GPS positions. Adversaries may still detect the presence of soldiers within this zone, but with reduced precision and accuracy compared to the inner and middle circles. By implementing this hierarchical cloaking mechanism within the mix-zone, we aim to thwart adversarial attempts to locate our soldiers while operating within IoBT deployments. This strategic approach ensures that soldiers remain protected and their movements clandestine, thereby enhancing the overall security and effectiveness of military operations in dynamic and hostile environments.

In our Random Walk Python simulator, we have implemented a mix-zone comprising only one circle out of a potential three circles. This implementation decision carries significant theoretical and practical implications within the context of location privacy preservation in Internet-of-Battlefield Things (IoBT) deployments.

From a theoretical perspective, the choice to incorporate a single circle within the mix-zone can be attributed to considerations of complexity, scalability, and efficacy. Mix-zones, designed to obfuscate the precise locations of users within IoBT networks, often rely on geometric shapes such as circles to delineate areas of anonymity. By limiting the implementation to a single circle, we aim to streamline the simulation process while retaining the essential characteristics of mix-zone functionality. This decision aligns with theoretical frameworks in spatial modeling and computational geometry, where simplified representations of complex phenomena are often employed to facilitate analysis and interpretation.

Moreover, the selection of a single circle in our implementation reflects practical constraints and trade-offs inherent in IoBT system design. While a mix-zone comprising multiple circles may offer enhanced coverage and robustness against location inference, it also introduces additional computational overhead and logistical challenges in deployment and management. By focusing on a single circle configuration, we strike a balance between computational efficiency and effectiveness in preserving location privacy, thereby optimizing the trade-off between complexity and utility in real-world IoBT scenarios.

Furthermore, from an academic standpoint, the decision to implement only one circle within the mix-zone provides a foundation for future research and experimentation. By establishing a baseline configuration, researchers can systematically explore the impact of varying mix-zone parameters, such as circle size, placement, and overlap, on location privacy and system performance. This approach fosters a deeper understanding of the underlying mechanisms driving mix-zone behavior and enables the identification of optimal design strategies for mitigating location inference risks in IoBT environments.

In summary, the implementation of a single circle within the mix-zone in our random walk Python simulator embodies a nuanced balance between theoretical rigor, practical considerations, and academic exploration. By simplifying the complexity of mix-zone configuration while preserving essential functionality, we lay the groundwork for comprehensive investigations into location privacy preservation techniques and their implications for IoBT security and resilience.

The mix-zone model depicted in FIG. 1B may not provide adequate protection to ensure users' location privacy. This limitation stems from the potential for a sophisticated observer to monitor the entry and exit points of users entering or leaving the mix-zone. An observer could deduce the estimated position of users by analyzing timing and velocity. This limitation can be at least partially addressed by dynamically adjusting size, shape, and other parameters of the expandable mix-zones in real-time. Moreover, the effectiveness of the mix-zone relies on the collaborative efforts of its users. Active participation in the exchange and blending of pseudonyms upon entering the mix-zone is necessary for users to collectively maintain anonymity within this area. Consequently, instances of non-participation or selfish behavior among users can significantly compromise the accuracy and efficacy of the entire system.

### Example Computing Device

Referring to FIG. 2, an example computing device 200 upon which embodiments of the invention may be implemented is illustrated. This disclosure contemplates that the controller(s) for operating the flexure elements and/or imaging apparatus can be implemented using a computing device 200. It should be understood that the example computing device 200 is only one example of a suitable computing environment upon which embodiments of the invention may be implemented. Optionally, the computing device 200 can be a well-known computing system including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 200 typically includes at least one processing unit 206 and system memory 204. Depending on the exact configuration and type of computing device, system memory 204 may be volatile (such as random-access memory (RAM)), non-volatile (such as read-only memory (ROM), flash memory, etc.), or some combination of the two. This most basic configuration is illustrated in FIG. 2 by the dashed line 202. The processing unit 206 may be a standard programmable processor that performs arithmetic and logic operations necessary for the operation of the computing device 200. The computing device 200 may also include a bus or other communication mechanism for communicating information among various components of the computing device 200.

Computing device 200 may have additional features/functionality. For example, the computing device 200 may include additional storage such as removable storage 208 and non-removable storage 210 including, but not limited to magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212, such as a display, speakers, printer, etc., may also be included. The additional devices may be connected to the bus in order to facilitate communication of data among the components of the computing device 200. All these devices are well-known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example of tangible, computer-readable media may include but is not limited to, volatile media, non-volatile media, removable media and non-removable media implemented in any method or technology for storage of information such as computer-readable instructions, data structures, program modules or other data. System memory 204, removable storage 208, and non-removable storage 210 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

### Example Method

Referring now to FIG. 3, a flowchart of an example computer-implemented method 300 for leveraging the disclosed expandable mix-zones is provided. In some implementations, the method 300 can be performed by a processing circuitry (for example, but not limited to, an application-specific integrated circuit (ASIC), or a central processing unit (CPU)). In some examples, the processing circuitry may be electrically coupled to and/or in electronic communication with other circuitries of an example computing device, such as, but not limited to, the example computing device 200 described above in connection with FIG. 2. In some examples, embodiments may take the form of a computer program product on a non-transitory computer-readable storage medium storing computer-readable program instruction (e.g., computer software). Any suitable computer-readable storage medium may be utilized, including non-transitory hard disks, CD-ROMs, flash memory, optical storage devices, or magnetic storage devices. This disclosure contemplates that some or all of the steps/operations below can be implemented using machine learning models and artificial intelligence-based techniques, such as, but not limited to, deep learning models as described in more detail below.

Optionally, at step/operation 310, the method 300 includes establishing or defining a plurality of expandable mix-zones and/or determining a priority level for each expandable mix-zone. This disclosure contemplates that the size, shape, definition, and/or associated parameters (e.g., geographical area, priority level, and/or the like) of each expandable mix-zone is adjustable/adaptable in real-time based on a control signal or modification provided by a command center or computing device (e.g., processing system 110) as determined based on, for example, new or changing field conditions. The plurality of expandable mix-zones can include at least a first mix-zone, a second mix-zone, and a third mix-zone, where each mix-zone is associated with a different location masking operation and/or priority level. In some implementations, the mix-zones do not intersect with one another and are concentrically nested within one another.

Additionally and/or alternatively, at step/operation 320, the method 300 includes receiving geographic information that defines the plurality of expandable mix-zones. In some embodiments, performance of the expandable mix-zones is modeled, analyzed, and/or optimized offline or by a command center using a Random Walk model.

At step/operation 330, the method 300 includes receiving location information for at least one computing device within one of the expandable mix-zones and/or reconfiguring the expandable mix-zones in real-time. The at least one computing device can be or comprise a drone, a tracking device, a wearable device, a mobile device, and an unmanned aerial vehicle (UAV), an Internet of Things (IOT) device, an Internet of Battlefield Things (IoBT) device, a Medical IoT device, combinations thereof, and/or the like. In some implementations, the method 300 includes monitoring environmental conditions via one or more sensors of the at least one computing device in order to dynamically reconfigure the expandable mix-zones in real-time (e.g., in response to a medical emergency detected from sensor information) and/or better modify and/or augment the location masking operations based on the detected environmental conditions.

At step/operation 340, the method 300 includes activating location masking operations to conceal the location of the at least one computing device while it is within one of the expandable mix-zones according to a corresponding (e.g., assigned or determined) priority level. The location masking operations can be configured to preserve and/or modulate access to short-term location information for Location-Based Services (LBS).

At step/operation 350, the method 300 includes, responsive to determining that the at least one computing device is positioned outside the plurality of expandable mix-zones, deactivating the location masking operations. In some implementations, step/operation 350 includes changing the location masking operations based on priority level as the computing device moves from one zone to another (e.g., from a low-priority zone to a higher-priority zone or from a high-priority zone to a lower priority zone).

At step/operation 360, the method 300 includes modifying and/or augmenting the location masking operations based on detected environmental conditions and/or received control signals (e.g., from a command center or remote device). By way of example, if a person's heart rate slows or increases beyond its normal range and the person stops moving for a predetermined amount of time, the processing system 110 may determine that the person is injured and can reconfigure the expandable mix-zones (e.g., increasing one or more zone sizes so that the person is moved from a low- or medium-priority zone to a high-priority zone). Step/operation 360 can include using random walk operations/models and/or machine-learning based techniques to modify or augment the location masking operations and/or reconfiguration of the expandable mix-zones.

### Machine Learning

Machine Learning. In addition to the machine learning operation described above, the exemplary system and method can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as a feature or features) to an output (also known as a target) during training with a labeled data set (or dataset). In an unsupervised learning model, the algorithm discovers patterns in the data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model.

A graph neural network (GNN) is a type of ANN that is configured to process graphical representations (i.e., graphs) of data/information. A graph is a structure comprising nodes where graph edges describe relationships between nodes. A graph can be described as G=(V, E) where G is the graph, V is a plurality of nodes, and E is a plurality of edges connecting the plurality of nodes. GNNs transmit information via a message passing mechanism where nodes aggregate information from their neighbors to update their representations (feature vectors) at each layer of the GNN. The GNN generates embeddings (n-dimensional vectors) for nodes that account for the node's features and the overall GNN structure.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing systems (e.g., a combination of a DSP and a microprocessor, a plurality of microprocessors, one or more microprocessors in conjunction with a DSP core, or any other such configuration). Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or codes on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

### Definitions

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising,” particularly in a description of components of a composition or in a description of elements of a device, can be exchanged with “consisting essentially of” or “consisting of.” The invention illustratively described herein suitably may be practiced in the absence of any element or elements, limitation, or limitations which is not specifically disclosed herein. In each instance herein, any of the terms “comprising,” “consisting essentially of,” and “consisting of” may be replaced with either of the other two terms.

All patents and publications mentioned in the specification are indicative of the levels of skill of those skilled in the art to which the invention pertains. References cited herein are incorporated by reference herein in their entirety to indicate the state of the art as of their filing date, and it is intended that this information can be employed herein, if needed, to exclude specific embodiments that are in the prior art.

One skilled in the art will readily appreciate that the present invention is well adapted to carry out the objects and obtain the ends and advantages mentioned, as well as those inherent therein. The devices, device elements, methods, and materials described herein as presently representative of preferred embodiments are exemplary and are not intended as limitations on the scope of the invention. Changes therein and other uses will occur to those skilled in the art and are intended to be encompassed within this invention.

As used herein, “about” refers to a value that is 10% more or less than a stated value.

The patents, applications, and publications, as listed below and throughout this document, are hereby incorporated by reference in their entirety herein.

### REFERENCE LIST #1

[1] K. Roy, Advances in ICT and the Likely Nature of Warfare. Routledge, 2019.
[2] M. B. Weimer, “Tactical deception capabilities in the heavy division-myth versus reality,” Monograph, School of Advanced Military Studies, US Army Command and General Staff College, Fort Leavenworth, KS, 1987.
[3] F. Galgano and E. J. Palka, Modern military geography. Routledge, 2012.
[4] C. D. J. N. Nair, Emerging Defence, Maritime and Aerospace Technologies by DRaS. Highlyy Publishing LLP, 2023.
[5] P. Pietrzak, Analyzing Global Responses to Contemporary Regional Conflicts. IGI Global, 2024.
[6] F. Al-Turjman, M. Abujubbeh, A. Malekloo, and L. Mostarda, “Uavs assessment in software-defined iot networks: An overview,” Computer Communications, vol. 150, pp. 519-536, 2020.
[7] M. Wigness, T. Pham, S. Russell, and T. Abdelzaher, “Efficient and resilient edge intelligence for the internet of battlefield things,” NATO S&T Journal, 2021.
[8] I. Butun, “Prevention and detection of intrusions in wireless sensor networks,” 2013.
[9] I. Butun and P. Osterberg, “Detecting intrusions in cyber-physical systems of smart cities: Challenges and directions,” Secure Cyber-Physical Systems for Smart Cities, pp. 74-102, 2019.
[10] V. Varghese, S. S. Desai, and M. J. Nene, “Decision making in the battlefield-of-things,” Wireless Personal Communications, vol. 106, pp. 423-438, 2019.
[11] M. Tortonesi, A. Morelli, M. Govoni, J. Michaelis, N. Suri, C. Stefanelli, and S. Russell, “Leveraging internet of things within the military network environment-challenges and solutions,” in 2016 IEEE 3rd World Forum on Internet of Things (WF-IoT). IEEE, 2016, pp. 111-116.
[12] B. E. Katalin, “Possibilities and security challenges of using iot for military purposes,” Hadmernok, vol. 13, no. 3, pp. 378-390, 2018.
[13] I. Butun and I. F. Akyildiz, “Low-power wide-area networks: Opportunities, challenges, risks and threats,” 2023.
[14] A. Amouri, V. T. Alaparthy, and I. Butun, “Ids and ips in lpwan (lorawan, sigfox, and nb-iot),” in Low-Power Wide-Area Networks: Opportunities, Challenges, Risks and Threats. Springer, 2023, pp. 39-82.
[15] S. Paul, M. Silaghi, V. Kepuska, A. Alghanmi, and S. Liu, “Mobile fog ai for internet of battlefield things (iobt),” in The International FLAIRS Conference Proceedings, vol. 37, 2024.
[16] G. Mois, S. Folea, and T. Sanislav, “Analysis of three iot-based wireless sensors for environmental monitoring,” IEEE Transactions on Instrumentation and Measurement, vol. 66, no. 8, pp. 2056-2064, 2017.
[17] A. A. Alquwayzani and A. A. Albuali, “A systematic literature review of zero trust architecture for uav security systems in iobt,” 2024.
[18] S. L. Pardau, “The california consumer privacy act: Towards a europeanstyle privacy regime in the united states,” J. Tech. L. & Pol′y, vol. 23, p. 68, 2018.
[19] L. Determann and J. Tam, “The california privacy rights act of 2020: A broad and complex data processing regulation that applies to businesses worldwide,” Journal of Data Protection & Privacy, vol. 4, no. 1, pp. 7-21, 2020.
[20] H. Li, L. Yu, and W. He, “The impact of gdpr on global technology development,” pp. 1-6, 2019.
[21] J. Qadir, J. E. U. Cabus, I. Butun, R. Lagerstrom, P. Gastaldo, and D. D. Caviglia, “Analysis of lpwan: Cyber-security vulnerabilities and privacy issues in lorawan, sigfox, and nb-iot,” in Low-PowerWide-Area Networks: Opportunities, Challenges, Risks and Threats. Springer, 2023, pp. 139-170.
[22] I. Butun and M. Imadeldin, “Expandable mix-zones as a deception technique for providing location privacy on internet-of-battlefield things deployments,” in 2024 International Conference on Smart Applications, Communications and Networking (SmartNets). IEEE, 2024, pp. 1-7.
[23] I. Butun and M. Gidlund, “Location privacy assured internet of things.” ICISSP, vol. 19, pp. 1-8, 2019.
[24] I. Butun, P. Osterberg, and M. Gidlund, “Preserving location privacy in cyber-physical systems,” in 2019 IEEE Conference on Communications and Network Security (CNS). IEEE, 2019, pp. 1-6.
[25] F. Marlind and I. Butun, “Activation of lorawan end devices by using public key cryptography,” in 2020 4th Cyber Security in Networking Conference (CSNet). IEEE, 2020, pp. 1-8.
[26] J. Qadir, I. Butun, R. Lagerstrom, P. Gastaldo, and D. D. Caviglia, “Towards smart sensing systems: A new approach to environmental monitoring systems by using lorawan,” in 2022 IEEE Zooming Innovation in Consumer Technologies Conference (ZINC). IEEE, 2022, pp. 176-181.
[27] I. Butun, N. Pereira, and M. Gidlund, “Security risk analysis of lorawan and future directions,” Future Internet, vol. 11, no. 1, p. 3, 2018.
[28] “Analysis of lorawan v1.1 security,” in Proceedings of the 4th ACM MobiHoc Workshop on Experiences with the Design and Implementation of Smart Objects, 2018, pp. 1-6.
[29] N. B. Gaikwad, H. Ugale, A. Keskar, and N. Shivaprakash, “The internetof-battlefield-things (iobt)-based enemy localization using soldiers location and gunshot direction,” IEEE Internet of Things Journal, vol. 7, no. 12, pp. 11 725-11 734, 2020.
[30] M. J. Farooq and Q. Zhu, “On the secure and reconfigurable multi-layer network design for critical information dissemination in the internet of battlefield things (iobt),” IEEE Transactions on Wireless Communications, vol. 17, no. 4, pp. 2618-2632, 2018.
[31] E. Limouchi and I. Mahgoub, “Reinforcement learning-assisted threshold optimization for dynamic honeypot adaptation to enhance iobt networks security,” in 2021 IEEE Symposium Series on Computational Intelligence (SSCI). IEEE, 2021, pp. 1-7.
[32] Y. Feng, M. Li, C. Zeng, and H. Liu, “Robustness of internet of battlefield things (iobt): A directed network perspective,” Entropy, vol. 22, no. 10, p. 1166, 2020.
[33] B. Alkanjr and I. Mahgoub, “Location privacy-preserving scheme in iobt networks using deception-based techniques,” Sensors, vol. 23, no. 6, p. 3142, 2023.
[34] “A novel deception-based scheme to secure the location information for iobt entities,” IEEE Access, vol. 11, pp. 15 540-15 554, 2023.
[35] G. H. Weiss and R. J. Rubin, “Random walks: theory and selected applications,” Adv. Chem. Phys, vol. 52, pp. 363-505, 1983.
[36] Z. Burda, J. Duda, J.-M. Luck, and B. Waclaw, “Localization of the maximal entropy random walk,” Physical review letters, vol. 102, no. 16, p. 160602, 2009.
[37] G.-Y. Chang and D.-W. Chiou, “Localization algorithm for mobile sensor networks under the random walk model,” in 2012 12th International Conference on ITS Telecommunications. IEEE, 2012, pp. 758-763.
[38] M. Lutz, Programming python. “O'Reilly Media, Inc.”, 2001.

### REFERENCE LIST #2

[1] I. Butun and M. Gidlund, “Location privacy assured internet of things.” ICISSP, vol. 19, pp. 1-8, 2019.
[2] I. Butun, P. O″ sterberg, and M. Gidlund, “Preserving location privacy in cyber-physical systems,” in 2019 IEEE Conference on Communications and Network Security (CNS). IEEE, 2019, pp. 1-6.
[3] R. Rolfe, H. Brown, and S. Nash, “Defense electronics product reliability requirements,” ADA387515, Institute for Defense Analyses, 1997.
[4] N. B. Gaikwad, H. Ugale, A. Keskar, and N. Shivaprakash, “The internet-of-battlefield-things (iobt)-based enemy localization using soldiers location and gunshot direction,” IEEE Internet of Things Journal, vol. 7, no. 12, pp. 11 725-11 734, 2020.
[5] M. J. Farooq and Q. Zhu, “On the secure and reconfigurable multi-layer network design for critical information dissemination in the internet of battlefield things (iobt),” IEEE Transactions on Wireless Communications, vol. 17, no. 4, pp. 2618-2632, 2018.
[6] E. Limouchi and I. Mahgoub, “Reinforcement learning-assisted threshold optimization for dynamic honeypot adaptation to enhance iobt networks security,” in 2021 IEEE Symposium Series on Computational Intelligence (SSCI). IEEE, 2021, pp. 1-7.
[7] Y. Feng, M. Li, C. Zeng, and H. Liu, “Robustness of internet of battlefield things (iobt): A directed network perspective,” Entropy, vol. 22, no. 10, p. 1166, 2020.
[8] B. Alkanjr and I. Mahgoub, “Location privacy-preserving scheme in iobt networks using deception-based techniques,” Sensors, vol. 23, no. 6, p.3142, 2023.
[9], “A novel deception-based scheme to secure the location information for iobt entities,” IEEE Access, vol. 11, pp. 15 540-15 554, 2023.

What is claimed is:

1. A system comprising:
at least one computing device, the at least one computing device comprising:
at least one processor; and
a memory having instructions thereon, wherein the instructions when executed by the processor, cause the at least one processor to:
receive geographical information corresponding with a geographical location, wherein the geographical information defines a plurality of expandable mix-zones, wherein the plurality of expandable mix-zones is adjustable/adaptable in real-time based on a control signal or modification provided by a command center or computing device; and
responsive to determining that the at least one computing device is located within at least one expandable mix-zone, activate location masking operations to conceal (e.g., anonymize, obscure) the location of the computing device while it is within at least one expandable mix-zone according to a corresponding priority level associated with the respective expandable mix-zone.

2. The system of claim 1, wherein the instructions when executed by the at least one processor, cause the at least one processor to further:
responsive to determining that the at least one computing device is positioned outside of the at least one expandable mix-zone, deactivate the location masking operations.

3. The system of claim 1, wherein the location masking operations preserve and/or modulate access to short-term location information for Location-Based Services (LBS).

4. The system of claim 1, wherein the plurality of expandable mix-zones includes a first zone, a second zone, and a third zone do not intersect with one another and are concentrically nested within one another.

5. The system of claim 1, wherein the plurality of expandable mix-zones comprises a plurality of expandable mix-zones including at least a first mix-zone, a second mix-zone, and a third mix-zone, wherein each mix-zone is associated with a different location masking operation and/or priority level.

6. The system of claim 5, wherein the instructions when executed by the at least one processor, cause the at least one processor to further:
determine a priority level for the at least one computing device based on a geographic zone (zone 1, zone 2, zone 3) within the plurality of expandable mix-zones; and
determine/activate location masking operations based on the determined priority levels.

7. The system of claim 1, wherein the at least one computing device is further configured to:
monitor environmental conditions via one or more sensors; and
modify or augment the location masking operations and/or reconfigure the plurality of mix-zones based on detected environmental conditions.

8. The system of claim 1, wherein the at least one computing device comprises at least one of an Internet of Things (IOT) device, an Internet of Battlefield Things (IoBT) device, and a Medical IoT device.

9. The system of claim 1, wherein the at least one computing device comprises at least one of a drone, a tracking device, a wearable device, a mobile device, and an unmanned aerial vehicle (UAV).

10. The system of claim 1, wherein performance of the at least one expandable mix-zone is modeled, analyzed, and/or optimized offline or by a command center using a Random Walk model.

11. The system of claim 1, wherein the at least one computing device comprises a plurality of interconnected devices (e.g., IoT and/or IoBT devices) in electronic communication over a network.

12. A computer-implemented method comprising:
receiving, by at least one processor, geographical information that defines a plurality of expandable mix-zones, wherein the plurality of expandable mix-zones is adjustable/adaptable in real-time based on a control signal or modification provided by a command center or remote device;
receiving, by the at least one processor, location information for at least one computing device within one of the expandable mix-zones; and
responsive to determining that at least one computing device is located within one of the expandable mix-zones, activating, by the at least one processor, location masking operations to conceal (e.g., anonymize, obscure) a location of the at least one computing device while it is within the expandable mix-zone according to a corresponding priority level associated with the respective expandable mix-zone.

13. The computer-implemented method of claim 12, further comprising:
prior to receiving the geographical information, establishing or defining, by the at least one processor, the plurality of expandable mix-zones including at least a first zone corresponding with a first geographic area, a second zone corresponding with a second geographic area, and a third zone corresponding with a third geographic area.

14. The computer-implemented method of claim 13, wherein the first zone, the second zone, and the third zone do not intersect with one another and are concentrically nested within one another.

15. The computer-implemented method of claim 12, further comprising:
responsive to determining that the at least one computing device is positioned outside of the plurality of expandable mix-zones, deactivating, by the at least one processor, the location masking operations.

16. The computer-implemented method of claim 12, wherein the location masking operations preserve and/or modulate access to short-term location information for Location-Based Services (LBS).

17. The computer-implemented method of claim 12, further comprising:
determining, by the at least one processor, a priority level for each expandable mix-zone; and
determining/activating, by the at least one processor, location masking operations within each zone for one or more computing devices based on the determined priority levels.

18. The computer-implemented method of claim 12, further comprising:
monitoring, by the at least one processor, environmental conditions via one or more sensors of the at least one computing device; and
modifying or augmenting, by the at least one processor, the location masking operations and/or reconfiguring the plurality of expandable mix-zones based on detected environmental conditions.

19. The computer-implemented method of claim 12, wherein performance of the plurality of expandable mix-zones is modeled, analyzed, and/or optimized offline or by a command center using a Random Walk model.

20. A non-transitory computer-readable medium comprising a memory having instructions stored thereon which when executed by a processor cause the processor to at least:
receive geographical information corresponding with a geographical location, wherein the geographical information defines a plurality of expandable mix-zones, and wherein the plurality of expandable mix-zones is adjustable/adaptable in real-time based on a control signal or modification provided by a command center or remote device; and
responsive to determining that at least one computing device is located within the at least one expandable mix-zone, activate location masking operations to conceal the location of the at least one computing device while it is within at least one expandable mix-zone according to a corresponding priority level associated with the respective expandable mix-zone.
